(19) United States
(12) Patent Application Publication
(10) Pub. No.: US 2016/0226886 A1
(43) Pub. Date: Aug. 4, 2016

(54) SECURE WIRELESS LOCATION INTERFACE PROTOCOL

(71) Applicant: INTEL CORPORATION, Santa Clara, CA (US)

(72) Inventor: Itai STEINER, Petach Tikva (IL)

(21) Appl. No.: 15/021,987

(22) PCT Filed: Dec. 27, 2013
(86) PCT No.: PCT/US2013/077998

§ 371 Date: Mar. 15, 2016

Related U.S. Application Data
(60) Provisional application No. 61/895,646, filed on Oct. 25, 2013.

(51) Int. Cl. H04L 29/06; G01S 5/14; H04W 12/04; H04W 64/00; H04W 24/10; H04W 12/08; G01S 5/00; H04W 76/02

(52) U.S. Cl. CPC H04L 63/107; G01S 5/0063; G01S 5/14; H04W 76/02; H04W 64/00; H04W 24/10; H04W 12/08; H04W 12/04; H04L 63/0428; H04L 63/06; H04W 84/12

(57) ABSTRACT

Systems and techniques for time-of-flight (ToF) location determination, such as WiFi fine time measurement, with secure connections are described herein. A device may establish a secure connection between the device and a location server in order to obtain security information, such as encryption keys, access point locations, or other security-related information, which may be utilized for to perform a ToF location determination. The keys may correspond to one or more access points and be used to establish a secure connection between the device and each access points to securely perform a fine-time-measurement exchange without performing a key-exchange procedure to establish the secure connection. The device or access points may securely determine the location of the device based at least in part on a fine-time-measurement exchange without incurring additional security setup overhead processing.

### PRIORITY CLAIM

This patent application claims the benefit of priority to U.S. Provisional Patent Application Ser. No. 61/895,646, filed on Oct. 25, 2013, which is hereby incorporated by reference herein in its entirety.

### TECHNICAL FIELD

Embodiments pertain to wireless communications. Some embodiments relate to the use of wireless geo-location, more specifically, some embodiments relate to securely determining a location of a device within a space equipped with a wireless network.

### BACKGROUND

Accurately locating wireless network devices indoors is hampered by the general unavailability of signals from global navigation and positioning satellite systems and the computational cost associated with performing numerous location determinations from terrestrial sources. Additionally, it is possible for a malicious entity to impersonate a source of location information or attach a device such that the devices incorrectly determines its location or is provided with false location information. Thus there are general needs for secure systems and methods that reduce costs associated with accurately locating wireless devices indoors or at locations where other signals are unavailable to determine position.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is an illustration of an example configuration of a communication network architecture, in accordance with some embodiments;

FIG. 2 is a block diagram of an example wireless communication system, in accordance with some embodiments;

FIG. 3 depicts an example AP Geospatial Location ANQP-element, in accordance with some embodiments;

FIG. 4 depicts an example location information data structure that may include the security keys and other security-related information, in accordance with some embodiments;

FIG. 5 is a flowchart illustrating an example method for securely determining a position of a device, in accordance with some embodiments;

FIG. 6 illustrates a functional block diagram of a UE in accordance with some embodiments;

FIG. 7 is a block diagram illustrating a mobile device in accordance with some embodiments; and

FIG. 8 illustrates a block diagram of an example machine upon which any one or more of the techniques (e.g., methodologies) discussed herein may be performed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Various techniques and configurations described herein provide for a secure location discovery technique used in conjunction with wireless communications and network communications. The presently described location techniques may be used in conjunction with wireless communication between devices and access points. For example, a wireless local area network (e.g., Wi-Fi) may be based on, or compatible with, one or more of the Institute of Electrical and Electronics Engineers (IEEE) 802.11 standards.

With some network technologies, a process for establishing the location of a device may make use of a time of flight (TOF) measurement system to calculate the distances between the device and multiple access points (APs). TOF calculations may make use of fine time measurement techniques to determine distances between a device and a specific access point. For example, a device may request TOF information from two or more access points in order to establish a physical distance from each individual access point, and thereby determining an approximate physical location of the device with respect to the access points. In an example where the physical location of the access points is known, the access points may provide the device with that location information over a secure link such that the device, alone or in conjunction with the access points, may accurately and reliably determine a precise physical location of the device, for example, as a set of latitude and longitude values in a navigational coordinate system. In an example, an access point location server may provide location information for one or more access points to the device through a secure communication link. In order to provide a secured and authenticated location to the device using a TOF measurement technique, both the AP locations and the range measurements should be derived by trusted methods or procedures.

In connection with the presently described techniques, a wireless communications device may be utilized to establish a secure connection with a wireless communications access point, and to receive location information from a location server that may provide access point location-information through a secure connection. The access point location-information may include keys or other security information to allow the device to securely perform TOF measurements without incurring the cost of performing a key exchange to establish a secure connection. In an example, a secure and authenticated location service, utilizing TOF measurements, may be utilized for applications such as indoor location, enterprise asset tracking, documenting use and access rights to a secured location, or other situations where trusted methods or procedures may be desirable to avoid malicious or accidental errors in locating a device.

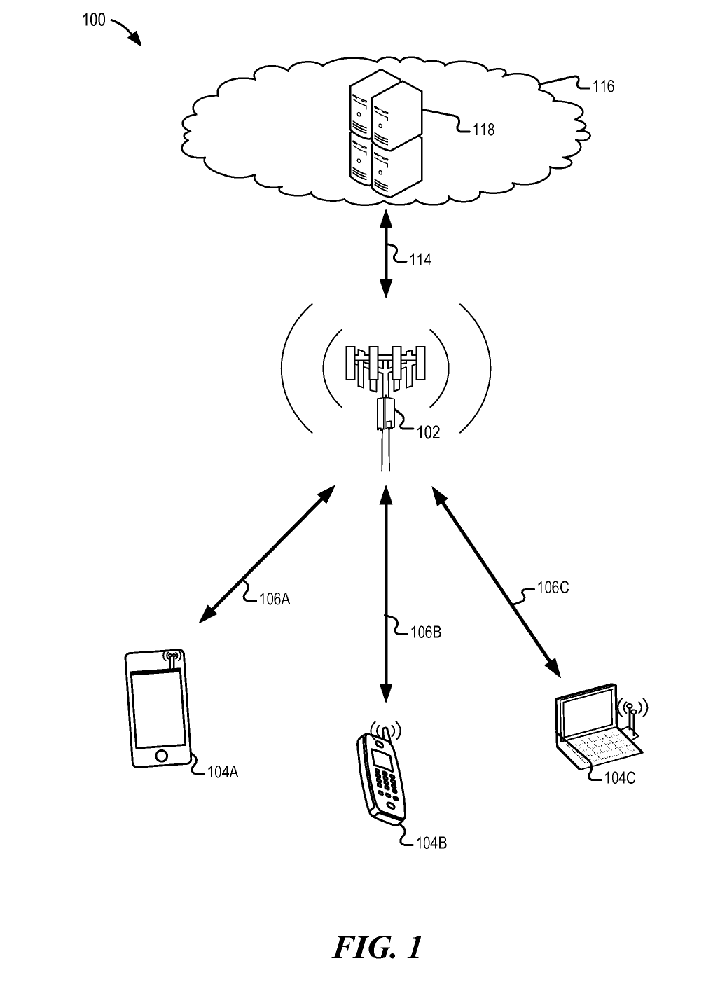

FIG. 1 provides an illustration of an example configuration of a communication network architecture 100. Within the communication network architecture 100, a carrier-based network such as an IEEE 802.11 compatible wireless access point or a LTE/LTE-A cell network operating according to a standard from a 3GPP standards family is established by network equipment 102. The network equipment 102 may include a wireless access point, a Wi-Fi hotspot, or an enhanced or evolved node B (eNodeB) communicating with communication devices 104A, 104B, 104C (e.g., a user equipment (UE) or a communication station (STA)). The carrier-based network includes wireless network connections 106A, 106B, and 106C with the communication devices 104A, 104B, and 104C, respectively. The communication devices 104A, 104B, 104C are illustrated as conforming to a variety of form factors, including a smartphone, a mobile phone handset, and a personal computer having an integrated or external wireless network communication device.

The network equipment 102 is illustrated in FIG. 1 as being connected via a network connection 114 to network servers 118 in a cloud network 116. The servers 118 may operate to provide various types of information to, or receive information from, communication devices 104A, 104B, 104C, including device location, user profiles, user information, web sites, e-mail, and the like. The techniques described herein enable the determination of the location of the various communication devices 104A, 104B, 104C, with respect to the network equipment 102 without requiring the various communication devices to establish a communication session with more than one network equipment.

Communication devices 104A, 104B, 104C may communicate with the network equipment 102 when in range or otherwise in proximity for wireless communications. As illustrated, the connection 106A may be established between the mobile device 104A (e.g., a smartphone) and the network equipment 102; the connection 106B may be established between the mobile device 104B (e.g., a mobile phone) and the network equipment 102; and the connection 106C may be established between the mobile device 104C (e.g., a personal computer) and the network equipment 102.

The wireless communications 106A, 106B, 106C between devices 104A, 104B, 104C may utilize a Wi-Fi or IEEE 802.11 standard protocol, or a protocol such as the current 3rd Generation Partnership Project (3GPP) long term evolution (LTE) time division duplex (TDD)-Advanced systems. In one embodiment, the communications network 116 and network equipment 102 comprises an evolved universal terrestrial radio access network (EUTRAN) using the 3rd Generation Partnership Project (3GPP) long term evolution (LTE) standard and operating in time division duplexing (TDD) mode. The devices 104A, 104B, 104C may include one or more antennas, receivers, transmitters, or transceivers that are configured to utilize a Wi-Fi or IEEE 802.11 standard protocol, or a protocol such as 3GPP, LTE, or TDD-Advanced or any combination of these or other communications standards.

Antennas in or on devices 104A, 104B, 104C may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to utilize spatial diversity and the different channel characteristics that may result between each of the antennas and the antennas of a transmitting station. In some MIMO embodiments, antennas may be separated by up to 1/10 of a wavelength or more.

In some embodiments, the mobile device 104A may include one or more of a keyboard, a display, a non-volatile memory port, multiple antennas, a graphics processor, an application processor, speakers, and other mobile device elements. The display may be an LCD screen including a touch screen. The mobile device 104B may be similar to mobile device 104A, but does not need to be identical. The mobile device 104C may include some or all of the features, components, or functionality described with respect to mobile device 104A.

A base station, such as an enhanced or evolved node B (eNodeB), may provide wireless communication services to communication devices, such as device 104A. While the exemplary communication system 100 of FIG. 1 depicts only three devices users 104A, 104B, 104C any combination of multiple users, devices, servers and the like may be coupled to network equipment 102 in various embodiments. For example, three or more users located in a venue, such as a building, campus, mall area, or other area, and may utilize any number of mobile wireless-enabled computing devices to independently communicate with network equipment 102. Similarly, communication system 100 may include more than one network equipment 102. For example, a plurality of access points or base stations may form an overlapping coverage area where devices may communicate with at least two instances of network equipment 102.

Although communication system 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements of system 100 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, system 100 may include one or more processors and may be configured with instructions stored on a computer-readable storage device.

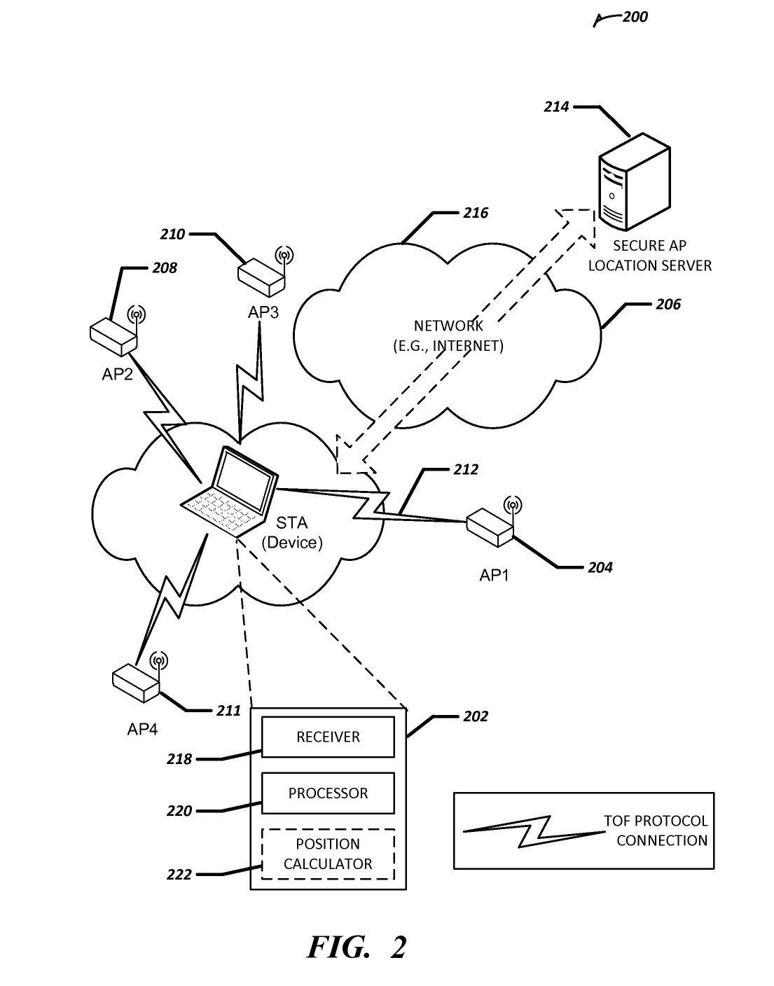

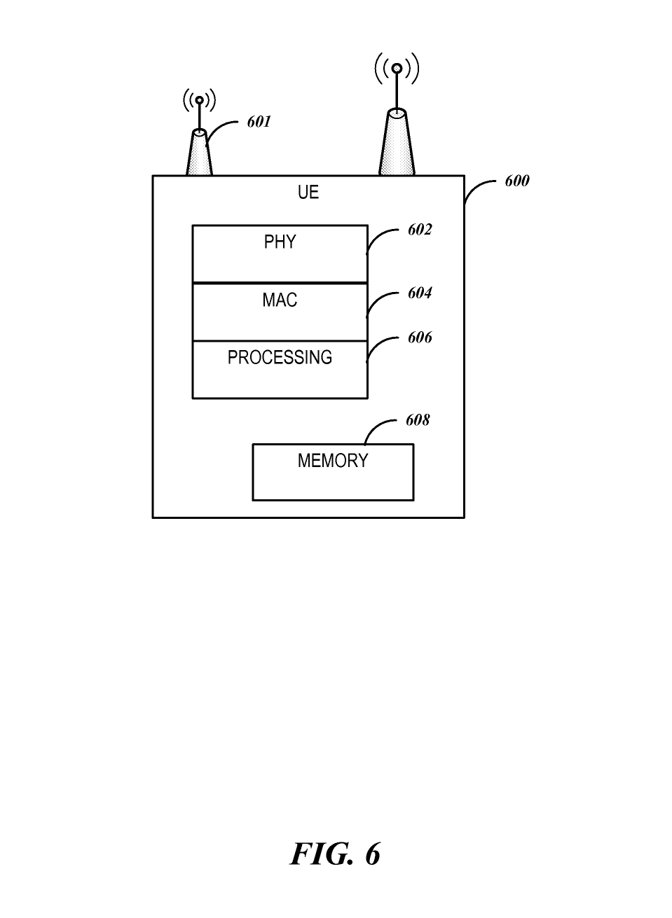

FIG. 2 is a block diagram of an example wireless communication system 200 that may utilize the communication network architecture 100 of FIG. 1. The exemplary communication system 200 may include a device 202 that is capable of wireless communication (e.g., a user equipment (UE) or communication station (STA)). The communication system 200 may include a device 202 that is capable of wireless communication. The device 202 may include a receiver 218 (e.g., as part of a transceiver) and a processor 220. The processor 220 may be any hardware, or subset of hardware, that can perform the specified operation. An enumeration of such hardware elements is given below with respect to FIG. 6, 7 or 8.

The processor 220 may be arranged to communicate with a position calculator 222. In an example, the position calculator 222 is local to (e.g., a part of, integrated with, belonging to, etc.) the device 202. In an example, the position calculator 222 is remote from (e.g., distant, accessible indirectly via a network (e.g., 206), in a different machine (e.g., server 214), etc.) from the device 202. When local, the processor 220 may perform the communication to the position calculator 222 via an interlink (e.g., bus, data port, etc.) of the device 202. When remote, the processor 220 may perform the communication to the position calculator via a network interface, such as via network interface card (NIC), or a wireless transceiver.

In an example, the device 202 may be a mobile computing device such as a cellular phone, a smartphone, a laptop, a tablet computer, a personal digital assistant or other electronic device capable of wireless communication. A first access point (AP) 204 may, for example, be a base station or a fixed wireless router. The device 202 may establish a secure communication link 212 with the first access point 204 in order to reach a network 206, such as the Internet. In an example, the device 202 may communicate with a secure access point locations server 214 via a secured link 216 over any available connection. For example, the device 202 may communicate with the secure access point locations server 214 via the secured link 216 through the first access point 204 and the network 206. The secured link 216 may, for example, utilize HyperText Transfer Protocol Secured (HTTPS) and transport layer security (TLS) to prevent the interception or unauthorized manipulation of data exchanged between the device 202 and the secure access point locations server 214. In an example, a cellular base station, such as network equipment 102 of FIG. 1, may provide the secured link 216 between the device 202 and the secure access point locations server 214.

In an example, a second access point 208 or a third access point 210 may be within range of the device 202. The device 202 may communicate with the first access point 204, the second access point 208 or the third access point 210. The device 202 may request location information regarding one or more of the first access point 204, the second access point 208, the third access point 210, or any other access point, from the secure access point locations server 214. In response to the location information request, the secure access point locations server 214 may provide the device 202, via secured link 216, with the location information corresponding to the requested access point. In an example, the secure access point locations server 214 may also provide the device 202 with one or more keys that the device 202 may utilize to securely communicate with the requested access point.

The first access point 204, the second access point 208, and the third access point 210 may all provide timing and/or location information to the device 202 over a secure communication link that may be established using a key, or other security information obtained by the device 202, from the secure access point locations server 214. The timing information may include time-of-arrival or time-of-departure data with respect to the TOF protocol exchange that are local to the each access point. The location information may include an updated location of a respective access point.

In an example, secured range measurement or fine time measurement may be utilized to separately establish a secured connection with each one of a plurality of access points (APs) that are within communication range of the device 202. The utilization of a secure protocol may, in some examples, incur overhead processing that may be reduced by the techniques discussed herein.

In an example, an exchange of keys may be performed when a device accesses an access point location server through a secured link. The access point location server may provide access point information, encryption keys, or other information (e.g., cipher suit type, key expiry, or other security-related information) that the device may utilized to establish a secure fine-time measurement protocol with each access point to measure a range from the access point (e.g., a distance between the access point and the device). In this manner, the exchange of keys between the device and a secure access point location server may eliminate the need to perform a key-exchange procedure as part of the secured fine-time-measurement with each AP individually, and thereby significantly reducing the air traffic, negotiation time, and protocol overhead. Keys may include cypher keys such as symmetric crypto keys, asymmetric crypto keys (public/private), WLAN 802.11i keys, PMF Keys, such as Unicast Key (Temporal Key part of the PTK from the 802.11i 4-Way Handshake), Multicast/Broadcast Key (GTK distributed by the 802.11i 4-Way or Group Key Handshake), PMK (Pairwise Master Key) or others.

In an example, a device may utilize a hypertext transfer protocol secure/transport layer security (HTTPS/TLS) connection to query the AP location server. The device may include a security key in the query. In response to the query, the AP location server may provide one or more security keys and other Security related information to the device in an AP location report. For example, the server may utilize a wireless local area network (WLAN) Access Network Query Protocol (ANQP) Element (via secured connection such as PMF). Accompanied by the inner LCI report as an optional elements to the ANQP, containing the security keys and other security related information, or as part of an extended LCI report that may include the security keys and other security related information.

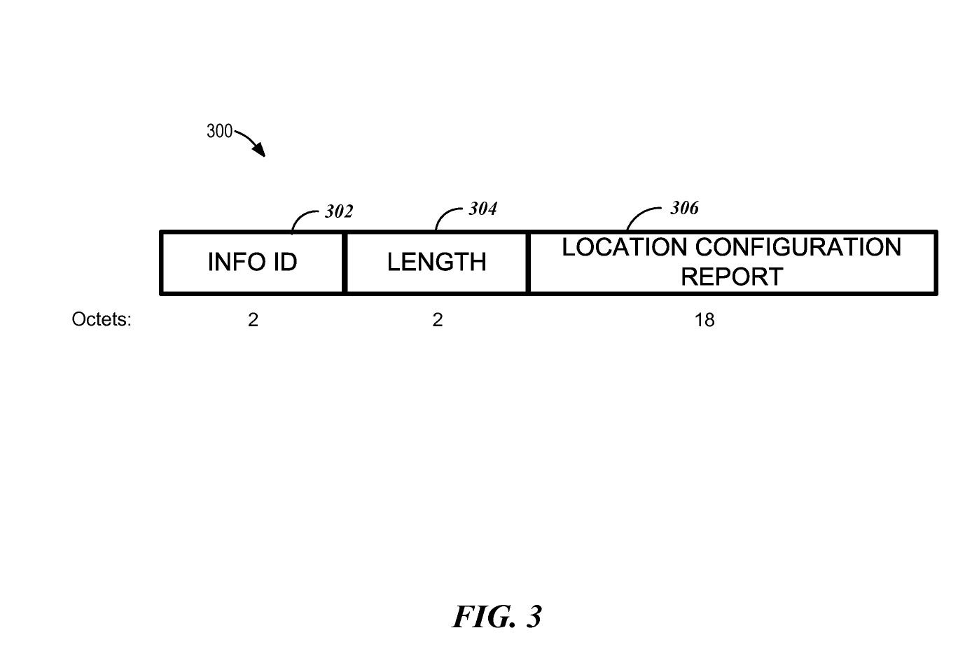

FIG. 3 depicts an example AP Geospatial Location ANQP-element 300. The AP Geospatial Location ANQP-element 300 provides the AP's location in an LCI format. The Info ID field 302 may include a value corresponding to the Geospatial Location ANQP-element. The length field 304 may is a two-octet field. In an example shown, the value is eighteen. The location configuration report 306 is an eighteen-octet field.

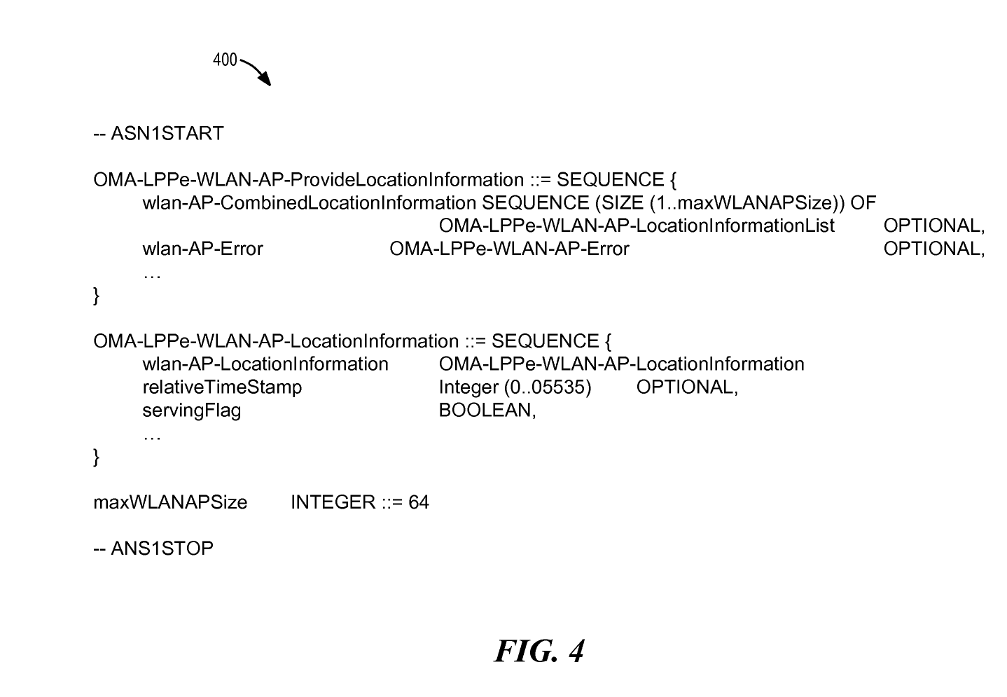

FIG. 4 depicts an example location information data structure 400 that may include the security keys and other security-related information. In an example, MA_LPPe-WLAN-AP-ProvideLocationlnformation may include a list of access point information element that include the security keys and other security-related information for respective access points.

In an example, a device and an AP location server may exchange location information and security information by utilizing an Open Mobile Alliance (OMA) Positioning Protocol Extensions (LPPe) protocol over secured protocol such as Secure User Plane Location (SUPL)/TLS.

Using the keys obtained by a device from an AP location server (e.g., Protected Management Frame (PMF) compliant keys) while obtaining access point location information, the Secured/Authenticated fine-time-measurement (ToF) protocol may be achieved by establishing a PMF protocol to perform a fine-time-measurement exchange without the standard PMF handshake (key-establishment procedure) and to transfer the keys, such as Unicast Key (Temporal Key part of the PTK from the 802.11i 4-Way Handshake), Multicast/Broadcast Key (GTK distributed by the 802.11i 4-Way or Group Key Handshake), PMK (Pairwise Master Key), or others. By establishing the PMF using a specific digital signature scheme or security scheme specifically for the fine-time-measurement air interface protocol.

These location techniques may facilitate the determination of a device location using any of a variety of network protocols and standards in licensed or unlicensed spectrum bands, including Wi-Fi communications performed in connection with an IEEE 802.11 standard (for example, Wi-Fi communications facilitated by fixed access points), 3GPP LTE/LTE-A communications (for example, LTE Direct (LTE-D) communications established in a portion of an uplink segment or other designated resources), machine-to-machine (M2M) communications performed in connection with an IEEE 802.16 standard, and the like.

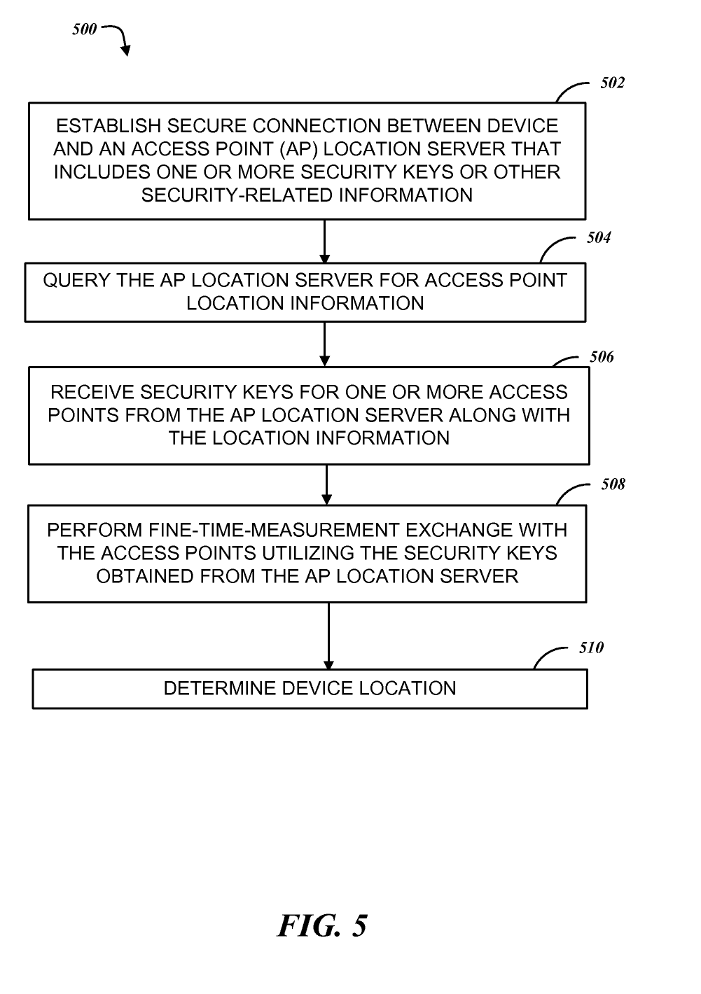

FIG. 5 is a flowchart illustrating an example method 500 for securely determining a position of a device in accordance with some embodiments. In an example, the method 500 may be performed by the device 202 of FIG. 2 in an attempt to securely exchange fine time measurement information with the access point 204 of FIG. 2.

At 502, the method 500 may begin with a device attempt to establish a secure connection between the device and an access point (AP) location server. The AP location server may include one or more security keys, or other security-related information. In an example, the device may utilize a Wi-Fi or IEEE 802.11 standard protocol, or a protocol such as the current 3GPP, LTE, or TDD-Advanced, to communicate with an access point that is configured to facilitate communication between the device and the AP location server.

At 504, the device may query the AP location server for access point location information. The query may include a request for geographic information regarding the access point the device is utilizing to communicate with the AP location server, or any other access point within communication range of the device.

At 506, in response to the query, the device may receive security keys for one or more access points from the AP location server along with the requested location information. In an example, the security keys may include cypher keys such as symmetric crypto keys, asymmetric crypto keys (public/private), WLAN 802.11i keys, PMF Keys, such as Unicast Key (Temporal Key part of the PTK from the 802.11i 4-Way Handshake), Multicast/Broadcast Key (GTK distributed by the 802.11i 4-Way or Group Key Handshake), PMK (Pairwise Master Key) or others.

At 508, the device may perform a fine-time-measurement exchange with the access points utilizing the security keys obtained from the AP location server. In an example, a secure and authenticated fine-time-measurement protocol may be utilized by establishing a PMF protocol connection to perform the fine-time-measurement exchange without a PMF handshake (key-establishment procedure) because the keys were previously obtained from the AP location server.

At 510, the device may determine a location of the device based on the fine-time-measurement exchange. In an example, the location may be an absolute geographic location. In an example, the location may be a relative location with respect to the access points.

Optionally, method 500 may include one or more operations defined by any of a variety of network protocols and standards in licensed or unlicensed spectrum bands, including Wi-Fi P2P communications performed in connection with an IEEE 802.11 standard (for example, Wi-Fi Direct communications facilitated by software access points (Soft APs)), 3GPP LTE/LTE-A communications (for example, LTE Direct (LTE-D) communications established in a portion of an uplink segment or other designated resources), machine-to-machine (M2M) communications performed in connection with an IEEE 802.16 standard, and the like.

Though arranged serially in the example of FIG. 5, other examples may reorder the operations, omit one or more operations, and/or execute two or more operations in parallel using multiple processors or a single processor organized as two or more virtual machines or sub-processors. Moreover, still other examples may implement the operations as one or more specific interconnected hardware or integrated circuit modules with related control and data signals communicated between and through the modules. Thus, any process flow is applicable to software, firmware, hardware, and hybrid implementations.

Although the preceding examples indicated the use of device-to-device communications in connection with 3GPP and 802.11 standard communications, it will be understood that a variety of other communication standards capable of facilitating device-to-device, machine-to-machine, and P2P communications may be used in connection with the presently described techniques. These standards include, but are not limited to, standards from 3GPP (e.g., LTE, LTE-A, HSPA+, UMTS), IEEE 802.11 (e.g., 802.11a, 802.11b, 802.11g, 802.11n, 802.11ac), 802.16 (e.g., 802.16p), or Bluetooth (e.g., Bluetooth 4.0, or other standard defined by the Bluetooth Special Interest Group) standards families. Bluetooth, as used herein, may refer to a short-range digital communication protocol defined by the Bluetooth Special Interest Group, the protocol including a short-haul wireless protocol frequency-hopping spread-spectrum (FHSS) communication technique operating in the 2.4 GHz spectrum.

FIG. 6 illustrates a functional block diagram of a UE 600 in accordance with some embodiments. The UE 600 may be suitable for use as device 102A (FIG. 1) or device 202 (FIG. 2). The UE 600 may include physical layer circuitry 602 for transmitting and receiving signals to and from eNBs using one or more antennas 601. UE 600 may also include processing circuitry 606 that may include, among other things a channel estimator. UE 600 may also include a memory 608. The processing circuitry may be configured to determine several different feedback values discussed below for transmission to the eNB. The processing circuitry may also include a media access control (MAC) layer 604.

In some embodiments, the UE 600 may include one or more of a keyboard, a display, a non-volatile memory port, multiple antennas, a graphics processor, an application processor, speakers, and other mobile device elements. The display may be an LCD screen including a touch screen.

The one or more antennas 601 utilized by the UE 600 may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated to take advantage of spatial diversity and the different channel characteristics that may result between each of antennas and the antennas of a transmitting station. In some MIMO embodiments, the antennas may be separated by up to 1/10 of a wavelength or more.

Although the UE 600 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage medium, which may be read and executed by at least one processor to perform the operations described herein. A computer-readable storage medium may include any non-transitory mechanism for storing information in a form readable by a machine (e.g., a computer). For example, a computer-readable storage medium may include read-only memory (ROM), random-access memory (RAM), magnetic disk storage media, optical storage media, flash-memory devices, and other storage devices and media. In these embodiments, one or more processors of the UE 600 may be configured with the instructions to perform the operations described herein.

In some embodiments, the UE 600 may be configured to receive OFDM communication signals over a multicarrier communication channel in accordance with an OFDMA communication technique. The OFDM signals may comprise a plurality of orthogonal subcarriers. In some broadband multicarrier embodiments, eNBs (including macro eNB and pico eNBs) may be part of a broadband wireless access (BWA) network communication network, such as a Worldwide Interoperability for Microwave Access (WiMAX) communication network or a 3rd Generation Partnership Project (3GPP) Universal Terrestrial Radio Access Network (UTRAN) Long-Term-Evolution (LTE) or a Long-Term-Evolution (LTE) communication network, although the scope of the inventive subject matter described herein is not limited in this respect. In these broadband multicarrier embodiments, the UE 600 and the eNBs may be configured to communicate in accordance with an orthogonal frequency division multiple access (OFDMA) technique. The UTRAN LTE standards include the 3rd Generation Partnership Project (3GPP) standards for UTRAN-LTE, release 8, March 2008, and release 10, December 2010, including variations and evolutions thereof.

In some LTE embodiments, the basic unit of the wireless resource is the Physical Resource Block (PRB). The PRB may comprise 12 sub-carriers in the frequency domain×0.5 ms in the time domain. The PRBs may be allocated in pairs (in the time domain). In these embodiments, the PRB may comprise a plurality of resource elements (REs). A RE may comprise one sub-carrier×one symbol.

Two types of reference signals may be transmitted by an eNB including demodulation reference signals (DM-RS), channel state information reference signals (CIS-RS) and/or a common reference signal (CRS). The DM-RS may be used by the UE for data demodulation. The reference signals may be transmitted in predetermined PRBs.

In some embodiments, the OFDMA technique may be either a frequency domain duplexing (FDD) technique that uses different uplink and downlink spectrum or a time-domain duplexing (TDD) technique that uses the same spectrum for uplink and downlink.

In some other embodiments, the UE 600 and the eNBs may be configured to communicate signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, the UE 600 may be part of a portable wireless communication device, such as a PDA, a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

In some LTE embodiments, the UE 600 may calculate several different feedback values which may be used to perform channel adaption for closed-loop spatial multiplexing transmission mode. These feedback values may include a channel-quality indicator (CQI), a rank indicator (RI) and a precoding matrix indicator (PMI). By the CQI, the transmitter selects one of several modulation alphabets and code rate combinations. The RI informs the transmitter about the number of useful transmission layers for the current MIMO channel, and the PMI indicates the codebook index of the precoding matrix (depending on the number of transmit antennas) that is applied at the transmitter. The code rate used by the eNB may be based on the CQI. The PMI may be a vector that is calculated by the UE and reported to the eNB. In some embodiments, the UE may transmit a physical uplink control channel (PUCCH) of format 2, 2a or 2b containing the CQI/PMI or RI.

In these embodiments, the CQI may be an indication of the downlink mobile radio channel quality as experienced by the UE 600. The CQI allows the UE 600 to propose to an eNB an optimum modulation scheme and coding rate to use for a given radio link quality so that the resulting transport block error rate would not exceed a certain value, such as 10%. In some embodiments, the UE may report a wideband CQI value which refers to the channel quality of the system bandwidth. The UE may also report a sub-band CQI value per sub-band of a certain number of resource blocks which may be configured by higher layers. The full set of sub-bands may cover the system bandwidth. In case of spatial multiplexing, a CQI per code word may be reported.

In some embodiments, the PMI may indicate an optimum precoding matrix to be used by the eNB for a given radio condition. The PMI value refers to the codebook table. The network configures the number of resource blocks that are represented by a PMI report. In some embodiments, to cover the system bandwidth, multiple PMI reports may be provided. PMI reports may also be provided for closed loop spatial multiplexing, multi-user MIMO and closed-loop rank 1 precoding MIMO modes.

In some cooperating multipoint (CoMP) embodiments, the network may be configured for joint transmissions to a UE in which two or more cooperating/coordinating points, such as remote-radio heads (RRHs) transmit jointly. In these embodiments, the joint transmissions may be MIMO transmissions and the cooperating points are configured to perform joint beamforming.

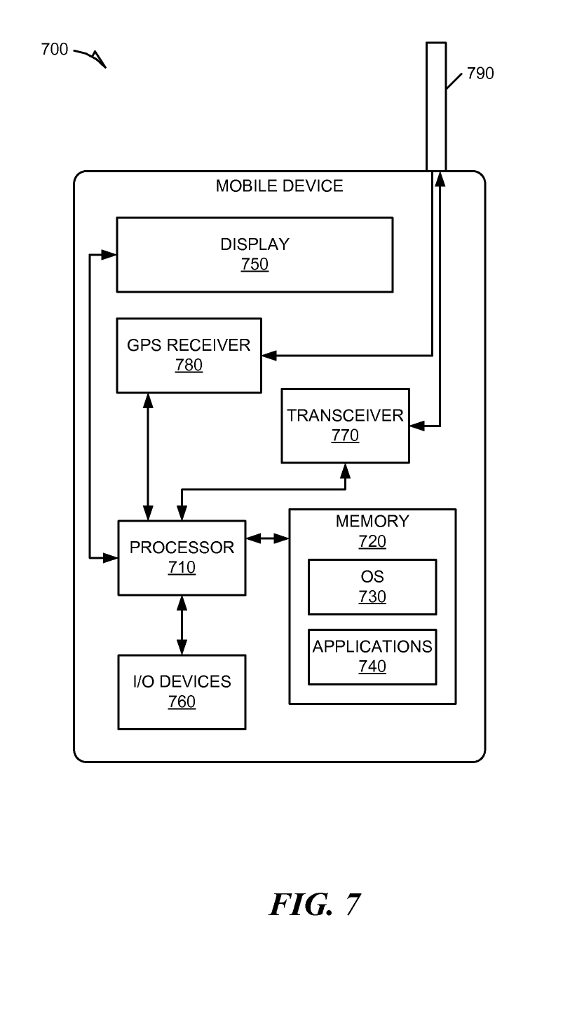

FIG. 7 is a block diagram illustrating a mobile device 700, upon which any one or more of the techniques (e.g., methodologies) discussed herein may be performed. The mobile device 700 may include a processor 710. The processor 710 may be any of a variety of different types of commercially available processors suitable for mobile devices, for example, an XScale architecture microprocessor, a Microprocessor without Interlocked Pipeline Stages (MIPS) architecture processor, or another type of processor. A memory 720, such as a Random Access Memory (RAM), a Flash memory, or other type of memory, is typically accessible to the processor 710. The memory 720 may be adapted to store an operating system (OS) 730, as well as application programs 740. The OS 730 or application programs 740 may include instructions stored on a computer readable medium (e.g., memory 720) that may cause the processor 710 of the mobile device 700 to perform any one or more of the techniques discussed herein. The processor 710 may be coupled, either directly or via appropriate intermediary hardware, to a display 750 and to one or more input/output (I/O) devices 760, such as a keypad, a touch panel sensor, a microphone, etc. Similarly, in an example embodiment, the processor 710 may be coupled to a transceiver 770 that interfaces with an antenna 790. The transceiver 770 may be configured to both transmit and receive cellular network signals, wireless data signals, or other types of signals via the antenna 790, depending on the nature of the mobile device 700. Further, in some configurations, a GPS receiver 780 may also make use of the antenna 790 to receive GPS signals.

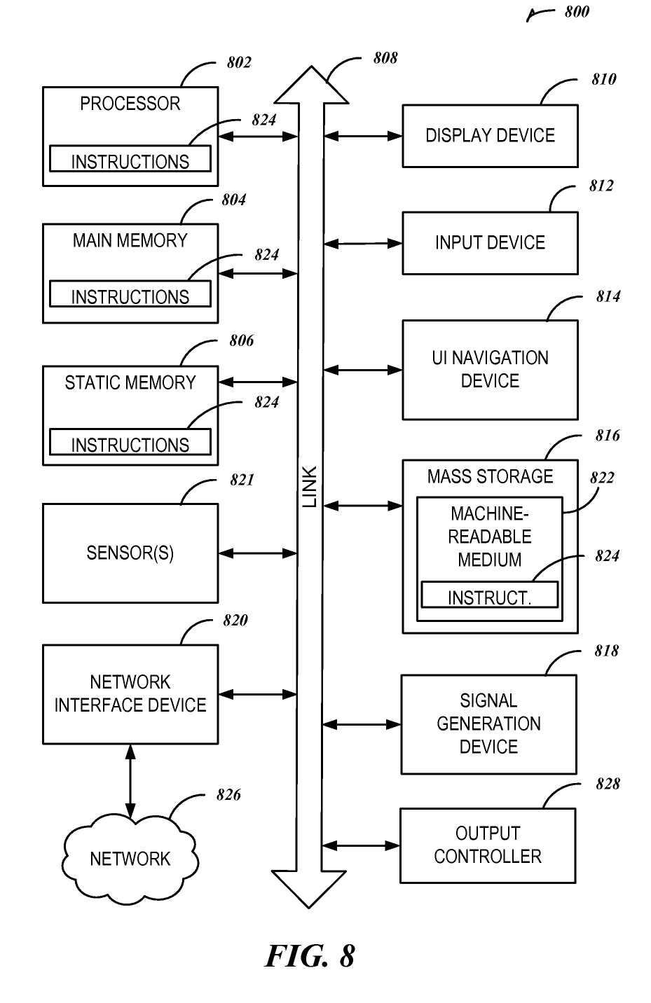

FIG. 8 illustrates a block diagram of an example machine 800 upon which any one or more of the techniques (e.g., methodologies) discussed herein may be performed. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a Personal Digital Assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 800 may include a hardware processor 802 (e.g., a processing unit, a graphics processing unit (GPU), a hardware processor core, or any combination thereof), a main memory 804, and a static memory 806, some or all of which may communicate with each other via a link 808 (e.g., a bus, link, interconnect, or the like). The machine 800 may further include a display device 810, an input device 812 (e.g., a keyboard), and a user interface (UI) navigation device 814 (e.g., a mouse). In an example, the display device 810, input device 812, and UI navigation device 814 may be a touch screen display. The machine 800 may additionally include a mass storage (e.g., drive unit) 816, a signal generation device 818 (e.g., a speaker), a network interface device 820, and one or more sensors 821, such as a global positioning system (GPS) sensor, camera, video recorder, compass, accelerometer, or other sensor. The machine 800 may include an output controller 828, such as a serial (e.g., universal serial bus (USB), parallel, or other wired or wireless (e.g., infrared (IR)) connection to communicate or control one or more peripheral devices (e.g., a printer, card reader, etc.).

The mass storage 816 may include a machine-readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the mass storage 816 may constitute machine-readable media.

While the machine-readable medium 822 is illustrated as a single medium, the term “machine readable medium” may include a single medium or multiple media (e.g., a centralized or distributed database, and/or associated caches and servers) that configured to store the one or more instructions 824.

The term “machine-readable medium” may include any tangible medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). The term “transmission medium” shall be taken to include any intangible medium that is capable of storing, encoding or carrying instructions for execution by the machine 800, and includes digital or analog communications signals or other intangible medium to facilitate communication of such software.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The example embodiments discussed herein may be utilized by wireless network access providers of all types including, but not limited to, mobile broadband providers looking to increase cellular offload ratios for cost-avoidance and performance gains, fixed broadband providers looking to extend their coverage footprint outside of customers' homes or businesses, wireless network access providers looking to monetize access networks via access consumers or venue owners, public venues looking to provide wireless network (e.g., Internet) access, or digital services (e.g. location services, advertisements, entertainment, etc.) over a wireless network, and business, educational or non-profit enterprises that desire to simplify guest Internet access or Bring-Your-Own-Device (BYOD) access.

What is claimed is:

1. A communication station (STA) for location determination in a wireless local area network (WLAN), the STA comprising:
a receiver to receive information for time-of-flight (ToF) measurements, the ToF measurements including a measurement of a radio signal between two positions;
a processor to:
establish a secure network connection with a secure location server;
receive access point information from the secure location server, the access point information including security information corresponding to an access point of the WLAN;
establish a secure connection with the access point with the security information; and
perform a secure ToF measurement exchange with the access point.

2. The STA of claim 1, comprising a security module, the security module to obtain the security information and establish the secure connection.

3. The STA of claim 1, wherein the measurement of the radio signal includes a fine-time-measurement, and the access point information includes security information corresponding to a plurality of access points.

4. The STA of claim 1, wherein the access point information includes a location of the network equipment, and the secure ToF measurement exchange with the access point includes determining a position of the STA.

5. The STA of claim 4, comprising a position calculator, the position calculator to use the results of the ToF measurement exchange, the position of the access point, and a second access point position to trilaterate a position of the STA.

6. The STA of claim 1, wherein the secure network connection with the secure location server and the secure connection with the access point are encrypted.

7. The STA of claim 1, wherein the network connection includes a wireless network connection performing wireless communications in accordance with a standard from: a 3GPP Long Term Evolution or Long Term Evolution-Advanced standards family, a standard from an IEEE 802.11 standards family, a standard from an IEEE 802.16 standards family, or a standard from a Bluetooth Special Interest Group standards family.

8. A method performed by a communication station (STA) for determining a location of the STA, the method comprising:
transmitting, by the STA, a location information request to an access point server;
receiving, by the STA, a location information response in response to the location information request, the location information response including security information corresponding to an access point;
establishing a secure connection between the STA and the access point with the security information;
performing a secure fine time measurement exchange with the access point via the secure connection;
calculating a distance between the STA and the access point based at least in part on the secure fine time measurement exchange.

9. The method of claim 8, wherein the secure time measurement exchange is encrypted with the security information.

10. The method of claim 9, wherein the security information corresponding to the access point includes a key to encrypt the secure fine time measurement exchange.

11. The method of claim 8, wherein the location information request and the location information response are exchanged over a secure network connection, and the location information response includes a location of the access point.

12. The method of claim 8, wherein the location information response includes security information corresponding to a plurality of access points.

13. The method of claim 12, comprising:
establishing a second secure connection between the STA and a second access point with the security information;
performing a second secure fine time measurement exchange with the second access point via the second secure connection;
calculating a second distance between the STA and the second access point based at least in part on the second secure fine time measurement exchange; and
determining a location of the STA based at least in part on the distance and the second distance by trilaterating the location of the STA.

14. The method of claim 8, wherein the secure network connection includes a wireless network connection performing wireless communications in accordance with a standard from: a 3GPP Long Term Evolution or Long Term Evolution-Advanced standards family, a standard from an IEEE 802.11 standards family, a standard from an IEEE 802.16 standards family, or a standard from a Bluetooth Special Interest Group standards family.

15. A secure location system comprising:
a wireless access point coupled to a network;
an access point location server coupled to the network; and
a device having a wireless communication module, the wireless communication module to establish a secure connection with the access point location server and securely request location information from the access point location server;
wherein the access point location server to provide the location information and security information corresponding to the wireless access point to the device, the wireless access point to securely exchange timing measurement information with the device over a secure connection established with the security information.

16. The secure location system of claim 15, comprising:
wherein the security information includes a key to encrypt the secure connection for the exchange.

17. The secure location system of claim 16, wherein the key is unique to the wireless access point.

18. The secure location system of claim 15, comprising:
a second wireless access point coupled to the network;
wherein the location information from the access point location server includes location information and security information corresponding to the second wireless access point, and the exchange of timing measurement information is performed according to a fine time measurement protocol by the device with the wireless access point and the second wireless access point.

19. The secure location system of claim 15, wherein the secure connection includes a wireless network connection performing wireless communications in accordance with a standard from: a 3GPP Long Term Evolution or Long Term Evolution-Advanced standards family, a standard from an IEEE 802.11 standards family, a standard from an IEEE 802.16 standards family, or a standard from a Bluetooth Special Interest Group standards family.

20. At least one machine readable medium comprising a plurality of instructions that in response to being executed on a computing device, cause the computing device to carry out a method according to any one of claims 8 through 14.

21. A communications device arranged to perform the method of any one of claims 8 through 14.
